(19) United States
(12) Patent Application Publication
(10) Pub. No.: US 2010/0134672 A1
(43) Pub. Date: Jun. 3, 2010

(54) UNIT PIXEL INCLUDING THREE TRANSISTORS AND PIXEL ARRAY INCLUDING THE UNIT PIXELS

(76) Inventor: Do Young Lee, Seongnam-si Kyeungki-do (KR)

Correspondence Address: HYUN JONG PARK;Park & Associates IP Law LLC, 265 Bic Drive, Suite 106, Milford, CT, 06461, US

(21) Appl. No.: 12/377,654

(22) PCT Filed: Aug. 10, 2007
(86) PCT No.: PCT/KR07/03837

§ 371 Date: Feb. 16, 2009

(30) Foreign Application Priority Data
Sep. 11, 2006 (KR) 10-2006-0087140

(51) Int. Cl. H04N 5/335

(52) U.S. Cl. 348/308; 348/E05.091

(57) ABSTRACT

Provided is a unit pixel which uses three transistors and a pixel array including the unit pixel. The unit pixel includes a photodiode, a charge passing unit, a reset controller, and a voltage converter. The pixel array has a structure in which a plurality of the unit pixels according to the present invention are two-dimensionally arrayed, and includes one or more reset power supply circuits which output two or more different supply voltages in response to a pixel selection control signal. Parts of a plurality of the unit pixels share a voltage output from the reset power supply circuit.

### TECHNICAL FIELD

The present invention relates to a unit pixel included in an image sensor, and more particularly, to a unit pixel that uses three transistors.

### BACKGROUND ART

FIG. 1 is a circuit diagram illustrating an embodiment of a unit pixel of a conventional complimentary metal-oxide semiconductor (CMOS) image sensor that uses four transistors.

Referring to FIG. 1, the unit pixel 100 includes a photodiode PD, a charge pass transistor M1, a reset transistor M2, a conversion transistor M3, and a pixel selection transistor M4.

The photodiode PD includes a terminal connected to a ground voltage GND and generates a charge in response to an image signal. The charge pass transistor M1 includes a terminal connected to the other terminal of the photodiode PD and a gate applied with a charge pass control signal TX. The reset transistor M2 includes a terminal connected to a supply voltage VDD, the other terminal connected to the other terminal of the charge pass transistor M1, and a gate applied with a reset control signal RE. The conversion transistor M3 includes a terminal connected to the supply voltage VDD and a gate that is commonly connected to the other terminal of the charge pass transistor M1 and the other terminal of the reset transistor M2. Here, a common terminal between the charge pass transistor M1 and the reset transistor M2 is called a floating diffusion area. The conversion transistor M3 generates a conversion voltage PIX-OUT corresponding to charge accumulated in the floating diffusion area. The pixel selection transistor M4 performs switching of the conversion voltage PIX-OUT in response to a pixel selection control signal SEL.

FIG. 2 is a circuit diagram illustrating another embodiment of the unit pixel of the conventional CMOS image sensor that uses four transistors.

Referring to FIG. 2, the unit pixel 200 includes a photodiode PD, a charge pass transistor M1, a reset transistor M2, a conversion transistor M3, and a pixel selection transistor M4.

The photodiode PD includes a terminal connected to a ground voltage GND and generates a charge in response to an image signal. The charge pass transistor M includes a terminal connected to the other terminal of the photodiode PD and a gate applied with a charge pass control signal TX. The reset transistor M2 includes a terminal connected to a supply voltage VDD, the other terminal connected to the other terminal of the charge pass transistor M1, and a gate applied with a reset control signal RE. The conversion transistor M3 outputs a conversion voltage PIX-OUT to a terminal of the conversion transistor M3 in response to voltages of the other terminal of the charge pass transistor M1 and the other terminal of the reset transistor M2, that are applied to a gate of the conversion transistor M3. The pixel selection transistor M4 includes a terminal connected to the supply voltage VDD, the other terminal connected to the other terminal of the conversion transistor M3, and a gate applied with a pixel selection control signal SEL.

Referring to FIGS. 1 and 2, a conventional pixel circuit detects an image signal by using four MOS transistors and converts the image signal into a voltage signal so as to be output. It is assumed that the MOS transistors illustrated in FIGS. 1 and 2 are N-type transistors. Therefore, when a high-state signal is applied to a gate, the MOS transistor is turned on, and when a low-state signal is applied thereto, the MOS transistor is turned off.

Hereinafter, operations of the pixel circuit will be described with reference to FIG. 3.

FIG. 3 is a waveform diagram of signals used in FIGS. 1 and 2.

Referring to FIG. 3, the pixel circuit 100 or 200 is ready to output the conversion voltage corresponding to the image signal detected by the photodiode PD, by the pixel selection control signal SEL that is firstly transited to a high-state. The gate VA of the conversion transistor M3, that is, the floating diffusion area VA is pre-charged with the supply voltage VDD by the reset control signal RE that is transited to the high-state after the pixel selection control SEL. Here, an amount of current that flows between a drain and a source of the conversion transistor M3 is determined by the supply voltage VDD applied to the gate of the conversion transistor M3, and the conversion voltage PIX-OUT output by the current that flows between the drain an the source is set to a reference voltage V1 (P1).

Next, when the pass control signal TX is in the high-state, the charge pass transistor M1 is turned on, and a conduction path is formed between the charge generated by the photodiode PD and the charges that are pre-charged to the node VA. When a difference between a voltage that is dropped by a charge generated by the image signal at the terminal of the charge pass MOS transistor M1 and a voltage VA that is dropped by the pre-charged charge at the other terminal of the charge pass MOS transistor M1 occurs, charges move through the conduction path. Due to the charges generated by the image signal, the number of pre-charged charges changes. After movements of the charges sufficiently occur, the pass control signal TX is transited to the low-state, and the movements of the charges do not occur any longer. Here, the number of charges accumulated in the gate of the conversion transistor M3 is changed, and the conversion voltage PIX-OUT determined by the changed number of charges is measured and set to a comparison voltage V2 (P2).

A difference between the reference voltage V1 and the comparison voltage V2 is processed as a detection voltage corresponding to the image signal detected by the pixel.

The pixel circuit 100 in FIG. 1 is different from the pixel circuit 200 in FIG. 2 in that the pixel circuit 100 outputs the conversion voltage PIX-OUT from the supply voltage VDD via the conversion transistor M3 and the pixel selection transistor M4, however, the pixel circuit 200 outputs the conversion voltage PIX-OUT from the supply voltage VDD via the pixel selection transistor M4 and the conversion transistor M3.

As described above, the pixel circuit which generates the charge corresponding to the image signal and outputs the conversion voltage corresponding to the generated charge uses at least four MOS transistors.

The photodiode that senses the image signal has the largest area in a pixel area, and as the area of the photodiode increases, the ability of the photodiode to sense image signal may be improved. However, the area of the photodiode may be influenced by the number and sizes of the MOS transistors. Specifically, as the number of the MOS transistors increases, the area of the photodiode in the limited entire pixel area decreases, so that a pixel circuit having a small number of MOS transistors may have a relatively improved ability to detect an image signal.

### DISCLOSURE OF INVENTION

### Technical Problem

The present invention provides a unit pixel using three transistors.

The present invention also provides a pixel array which includes a unit pixel using three transistors and a reset power supply circuit supplying two or more supply voltages having different levels from each other to the unit pixel.

### Technical Solution

According to an aspect of the present invention, there is provided a unit pixel which includes a photodiode, a charge passing unit, a reset controller, and a voltage converter. The photodiode generates a charge in response to the image signal, the charge passing unit passes the charge generated by the photodiode to the voltage converter in response to a charge pass control signal, the reset controller supplies two or more different supply voltages to a common terminal between the charge passing unit and the voltage converter in response to a reset control signal, and the voltage converter outputs the conversion voltage corresponding to charges accumulated in a common terminal between the charge passing unit and the reset controller.

According to another aspect of the present invention, there is provided a pixel array which has a structure in which a plurality of the unit pixels according to the present invention are two-dimensionally arrayed, and includes one or more reset power supply circuits which output two or more different supply voltages in response to a pixel selection control signal, wherein parts of a plurality of the unit pixels share a voltage output from the reset power supply circuit.

### BRIEF DESCRIPTION OF THE DRAWINGS

FIG. 1 is a circuit diagram illustrating an example of a unit pixel of a conventional complimentary metal-oxide semiconductor (CMOS) image sensor that uses four transistors.

FIG. 2 is a circuit diagram illustrating another example of the unit pixel of the conventional CMOS image sensor that uses four transistors.

FIG. 3 is a waveform diagram of signals used in FIGS. 1 and 2.

FIG. 4 illustrates a portion 400 of an image sensor including a unit pixel and a reset power supply circuit according to the present invention.

FIG. 5 illustrates an operation state of a circuit illustrated in FIG. 4 when a first control signal is enabled.

FIG. 6 illustrates an operation state of a circuit illustrated in FIG. 4 when a second control signal is enabled.

FIG. 7 is a waveform diagram of control signals used in FIG. 4.

FIG. 8 illustrates a portion of a pixel array which represents connection relationships between the reset power supply circuits and the unit pixels illustrated in FIG. 4.

FIG. 9 illustrates a portion of a pixel array which represents connection relationships between the reset power supply circuits and the unit pixels illustrated in FIG. 4.

FIG. 10 illustrates a pixel array which represents connection relationships between the reset power supply circuits and the unit pixels illustrated in FIG. 4 according to another embodiment.

FIG. 11 is a waveform diagram of signals associated with operations of the pixel array illustrated in FIG. 8.

FIG. 12 is a waveform diagram of signals associated with operations of the pixel array illustrated in FIGS. 9 and 10.

### BEST MODE FOR CARRYING OUT THE INVENTION

Hereinafter, exemplary embodiments of the present invention will be described in detail with reference to the attached drawings.

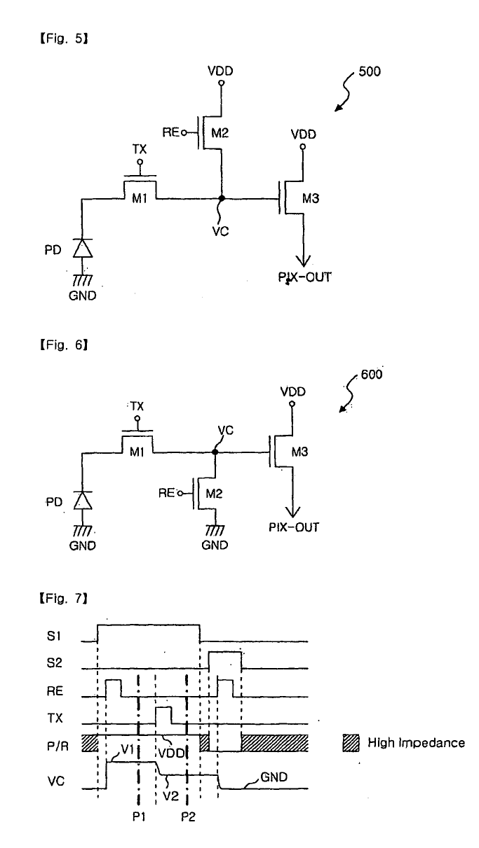

FIG. 4 illustrates a portion 400 of an image sensor including a unit pixel and a reset power supply circuit according to the present invention.

Referring to FIG. 4 that illustrates the portion 400 of the image sensor, the image sensor basically includes a plurality of unit pixels 450 that are two-dimensionally arrayed and one or more reset power supply circuits 410. The reset power supply circuit 410 supplies at least two supply voltages (VDD and GND) to the unit pixel 450 through a pre-charge/reset terminal P/R. In FIG. 4, it is illustrated that a single reset power supply circuit 410 is provided to each unit pixel 450, and this represents a connection relationship between the unit pixel 450 and the reset power supply circuit 410. However, a plurality of the unit pixels 450 may share a single reset power supply circuit 410 or plurality of the reset power supply circuits 410.

The reset power supply circuit 410 includes two switch elements M4 and M5. The fourth switch element M4 performs a switching operation on the second supply voltage VDD in response to a first control signal S1, and the fifth switch element M5 performs a switching operation on the first supply voltage GND in response to a second control signal S2. The first supply voltage GND is relatively lower than the second supply voltage VDD, and this may be changed according to electrical characteristics of the switch element. For example, when the two switch elements M4 and M5 are implemented by using N-type MOS transistors, and the two control signals S1 and S2 applied to gates thereof, respectively, are logically in a high-state, the switches are turned on.

The fourth switch element M4 transmits the second supply voltage VDD connected to a terminal of the fourth switch element M4 to a pre-charge/reset line P/R connected to the other terminal thereof in response to the control signal 51 applied to the gate thereof. The fifth switch element M5 transmits the first supply voltage GND connected to a terminal of the fifth switch element M5 to the pre-charge/reset line P/R connected to the other terminal thereof in response to the second control signal S2 applied to the gate thereof.

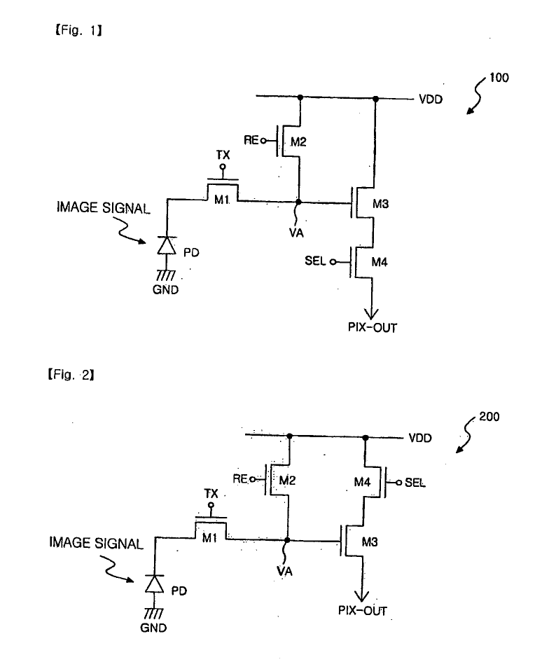

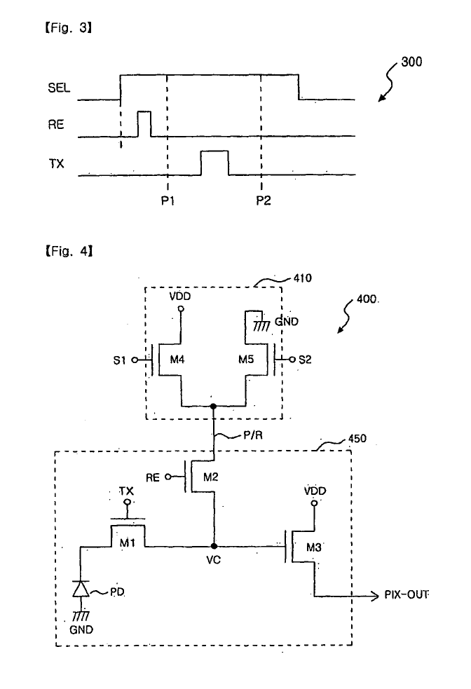

The first control signal S1 may use the pixel selection control signal SEL illustrated in FIGS. 1 and 2 as it is or may be generated by processing the pixel selection control signal SEL. The second control signal S2 has the same strength as the first control signal S1 and has an opposite phase thereto. When the fourth and fifth switch elements M4 and M5 are N-type MOS transistors, logic-high selections of the first and second control signals S1 and S2 to turn on the N-type MOS transistors do not overlap. On the contrary, when the fourth and fifth switch elements M4 and M5 are P-type MOS transistors, logic-low sections to turn on the P-type MOS transistors do not overlap. According to logic states of the first and second control signals S1 and S2, one of the first and second supply voltages GND and VDD is supplied to the unit pixel 450 through the pre-charge/reset line P/R. Here, the pixel selection control signal SEL is a signal for instructing charges sensed by the unit pixels which share the reset power supply circuit 410 to be converted into a voltage.

The unit pixel 450 includes a photodiode PD, a charge passing unit M1, a reset controller M2, and a voltage converter M3.

The photodiode PD has a terminal connected to the first supply voltage GND and generates a charge corresponding to energy of an incident image signal.

The charge passing unit M1 has a terminal connected to the other terminal of the photodiode PD, may be implemented as an N-type MOS transistor having a gate applied with a charge pass control signal TX, and transmits the charge generated by the photodiode PD to the gate of the voltage converter M3 in response to the charge pass control signal TX.

The reset controller M2 has a terminal connected to the pre-charge/reset line P/R, has the other terminal connected to the other terminal VC of the charge passing unit M1, may be implemented as an N-type MOS transistor having a gate applied with a reset control signal RE, and supplies two or more supply voltages VDD and GND that are different from each other and supplied through the pre-charge/reset line P/R to the other terminal VC thereof. Here, the other terminal VC is generally called a floating diffusion area.

The voltage converter M3 has a terminal connected to the second supply voltage VDD, may be implemented as an N-type MOS transistor having a gate that is commonly connected to the other terminal of the charge passing unit M1 and the other terminal of the reset controller M2, and outputs a conversion voltage PIX-OUT determined to correspond to the charges accumulated in the common terminal VC between the charge passing unit M1 and the reset controller M2.

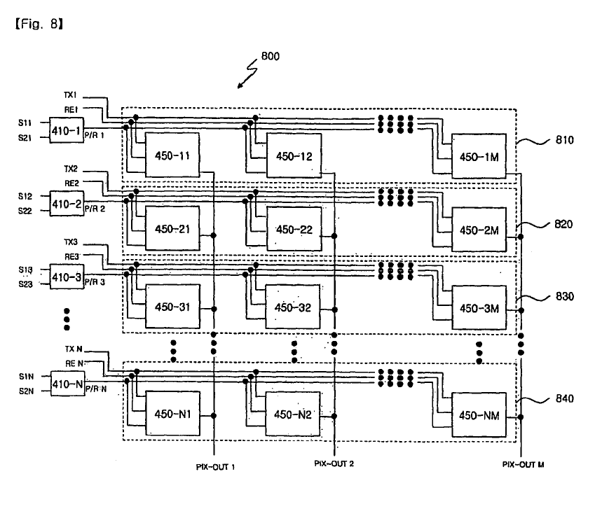

Now, pre-charge and reset operations of the unit pixel 450 illustrated in FIG. 4 will be described with reference to FIGS. 5 and 6. Here, it is assumed that when the first control signal S1 is enabled, the second supply voltage VDD is output through the pre-charge/reset line P/R, and when the second control signal S2 is enabled, the first supply voltage GND is output.

FIG. 5 illustrates an operation state of the circuit illustrated in FIG. 4 when the first control signal is enabled.

Referring to FIG. 5, since the second supply voltage VDD is supplied to the terminal of the reset controller M2, when the reset controller M2 is turned on, the common node VC between the charge passing unit M1, the reset controller M2, and the voltage converter M3 is pre-charged with charges corresponding to a level of the second supply voltage VDD.

FIG. 6 illustrates an operation state of the circuit illustrated in FIG. 4 when the second control signal is enabled.

Referring to FIG. 6, since the first source voltage GND is supplied to the terminal of the reset controller M2, when the reset controller M2 is turned on, the common node VC between the charge passing unit M1, the reset controller M2, and the voltage converter M3 is reset with charges corresponding to a level of the first supply voltage GND.

Hereinafter, operations of the image sensor including the unit pixel 450 and the reset power supply circuit 410 according to the present invention will be described and it is assumed that the charge passing unit M1, the reset controller M2, and the voltage converter M3 are the N-type MOS transistors.

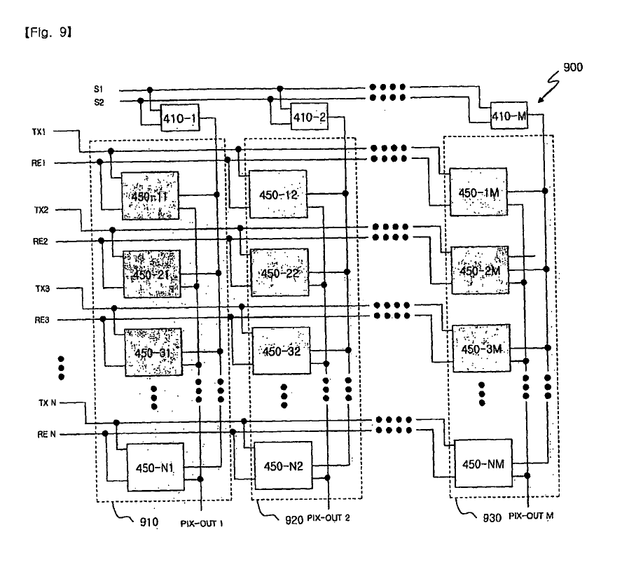

FIG. 7 is a waveform diagram of control signals used in FIG. 4.

Referring to FIG. 7, in the unit pixel 450, the pixel selection control signal SEL or the first control signal S1 is transited to a logic-high state for a predetermined time interval, and the second supply voltage VDD supplied from the reset power supply circuit 410 through the pre-charge/reset line P/R is supplied to the terminal of the reset controller M2 while the first control signal S1 is in the logic-high state.

Next, the reset control signal RE maintains a logic-high state for a predetermined time interval. During the time interval, the reset controller M2 is turned on, and charges supplied from the second supply voltage VDD are accumulated into the floating diffusion area that is the common node VC between the other terminal of the reset controller M2, the other terminal of the charge passing unit M1, and the gate terminal of the voltage converter M3. The charge can be supplied to the common node VC only through the charge passing unit M1 and the reset controller M2. However, during the time interval, the charge passing unit M1 is turned off. Therefore, during the time interval, a source that can supply the charge to the node NVC is only the second supply voltage VDD that is applied through the reset controller M2, so that a voltage represented by the charges accumulated in the node VC is the second supply voltage VDD. Here, the voltage charged to the common node VC is defined as a voltage V1.

Here, in response to the voltage level V1 applied to the common node VC, that is, the gate of the voltage converter M3, a corresponding current flows from the second supply voltage VDD connected to the terminal of the voltage converter M3 to the other terminal thereof. In this case, a voltage level of the other terminal of the voltage converter M3 is determined by the current that flows from the terminal to the other terminal of the voltage converter M3. This voltage is obtained by converting the charges accumulated in the gate of the voltage converter M3, so that the voltage is defined as the conversion voltage PIX-OUT and is set to the reference voltage Vo1 (P1).

Next, when the pass control signal TX is in a high-state for a predetermined time interval, the charge passing unit M1 is turned on, and a conduction path is formed between the charge generated by the photodiode PD and the charges pre-charged to the node VC. Between the charge generated by the image signal and the charges accumulated in the node VC, diffusion, drift, and/or recombination occur, and this may cause a change in an amount of charges accumulated in the common node VC. When the pass control signal TX is transited to the low-state after the diffusion, drift, and/or recombination of the charges sufficiently occur, a state where an amount of charges accumulated in the common node VC is changed is fixed, and the voltage of the common node VC in this case is defined as a voltage V2.

Here, the conversion voltage PIX-OUT that is determined by the changed number of charges accumulated in the gate of the voltage converter M3 is measured and set to a comparison voltage Vo2 (P2).

Next, a detection voltage corresponding to the image signal detected by the pixel is generated by using the reference voltage Vo1 and the comparison voltage Vo2. In this case, in general, a difference between the reference voltage Vo1 and the comparison voltage Vo2 is processed as the detection voltage.

After the aforementioned operations are terminated, and after the pixel selection control signal SEL or the first control signal S1 is in a low-state, a predetermined time elapses, and the second control signal S2 is transited to the high-state for a pre-determined time. During the time when the second control signal S2 maintains the high-state, the first supply voltage GND is supplied to the terminal of the reset controller M2 through the pre-charge/reset line P/R. When the reset control signal RE is transited to the high-state for a predetermined time while the second control signal S2 maintains the high-state during the time interval, a charge passing path is formed between the common node VC and the first supply voltage GND during the time interval. Here, all charges that remain at the common node VC are discharged to the first supply voltage GND, so that an advantage in that the charges that remain at the common node VC do not affect charge detection of a next cycle can be obtained.

A hatched portion in the pre-charge/reset line P/R is in a high-impedance state but does not correspond to the first supply voltage GND or the second supply voltage VDD.

As described above, operations of the unit pixel that uses three MOS transistors according to the present invention are not significantly different from those of the conventional unit pixel that uses four MOS transistors and is operated by signals described with reference to FIGS. 1 to 3. Therefore, the unit pixel according to the present invention can replace the conventional unit pixel used by the image sensor in a one-to-one manner.

FIG. 8 illustrates a pixel array which represents connection relationships between the reset power supply circuits and the unit pixels illustrated in FIG. 4 according to an embodiment.

Referring to FIG. 8, a pixel array 800 includes N reset power supply circuits 410-1 to 410-N (N is an integer) and unit pixel groups 810 to 840, each in which M unit pixels (M is an integer) are arrayed in a horizontal direction.

A first reset power supply circuit 410-1 supplies one of the first supply voltage GND and the second supply voltage VDD to a first unit pixel group 810 through a first pre-charge/reset line P/R1 in response to a first control signal S11 and a second control signal S21. The first unit pixel group 810 includes M unit pixels 450-11 to 450-1M, and each of the M unit pixels 450-11 to 450-1M is operated in response to the supply voltage, a first pass control signal TX1, and a first reset control signal RE1 that are transmitted through the first pre-charge/reset line P/R1.

A second reset power supply circuit 410-2 supplies one of the first supply voltage GND and the second supply voltage VDD to a second unit pixel group 820 through a second pre-charge/reset line P/R2 in response to a first control signal S12 and a second control signal S22. The second unit pixel group 820 includes M unit pixels 450-21 to 450-2M, and each of the M unit pixels 450-21 to 450-2M is operated in response to the supply voltage, a second pass control signal TX2, and a second reset control signal RE2 that are transmitted through the second pre-charge/reset line P/R2.

An n-th reset power supply circuit 410-N supplies one of the first supply voltage GND and the second supply voltage VDD to an n-th unit pixel group 840 through an n-th pre-charge/reset line P/RN in response to a first control signal S1N and a second control signal S2N. The n-th unit pixel group 840 includes M unit pixels 450-N1 to 450-NM, and each of the M unit pixels 450-N1 to 450-NM is operated in response to the supply voltage, an n-th pass control signal TXN, and an n-th reset control signal REN that are transmitted through the n-th pre-charge/reset line P/RN.

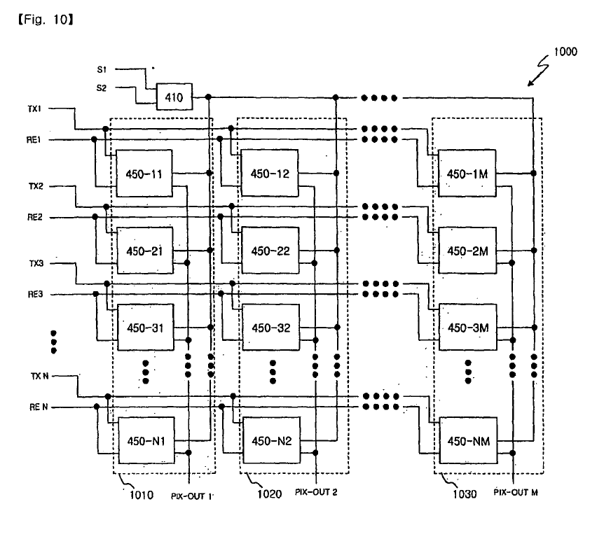

FIG. 9 illustrates of a pixel array which represents connection relationships between the reset power supply circuits and the unit pixels illustrated in FIG. 4 according to another embodiment.

Referring to FIG. 9, the pixel array 900 includes M reset power supply circuits 410-1 to 410-M (M is an integer) and M unit pixel groups 910 to 930, each in which unit pixels are arrayed in a vertical direction.

Each of the M reset power supply circuits 410-1 to 410-M outputs one of the first supply voltage GND and the second supply voltage VDD in response to a first control signal S11 and a second control signal S21.

A first unit pixel group 910 includes N unit pixels 450-11 to 450-N1. A first unit pixel 450-11 is operated in response to the supply voltage, a first pass control signal TX1, and a first reset control signal RE1 that are transmitted through a first pre-charge/reset line P/R1. A second unit pixel 450-21 is operated in response to the supply voltage, a second pass control signal TX2, and a second reset control signal RE2 that are transmitted through the first pre-charge/reset line P/R1. An n-th unit pixel 450-N1 is operated in response to the supply voltage, an n-th pass control signal TXN, and an n-th reset control signal REN that are transmitted through the first pre-charge/reset line P/R1.

A second unit pixel group 920 includes N unit pixels 450-12 to 450-N2. A construction of the N unit pixels 450-12 to 450-N2 included in the second unit pixel group 920 is the same as that of the N unit pixels 450-11 to 450-N1 included in the first unit pixel group 910, so that a detailed description thereof is omitted. For the same reason, a construction of the m-th unit pixel group 930 is omitted.

FIG. 10 illustrates a pixel array which represents connection relationships between the reset power supply circuits and the unit pixels illustrated in FIG. 4 according to another embodiment.

Referring to FIG. 10, the pixel array 1000 includes a reset power supply circuit 410 and M unit pixel groups (M is an integer) 1010 to 1030 each in which unit pixels are arrayed in a vertical direction. Except for the fact that the number of the reset power supply circuit 410 is one, a construction of the unit pixel groups 1010 to 1030 is the same as that illustrated in FIG. 9, so that a detailed description of the construction is omitted.

Hereinafter, operations of the pixel arrays illustrated in FIGS. 8 to 10 will be described.

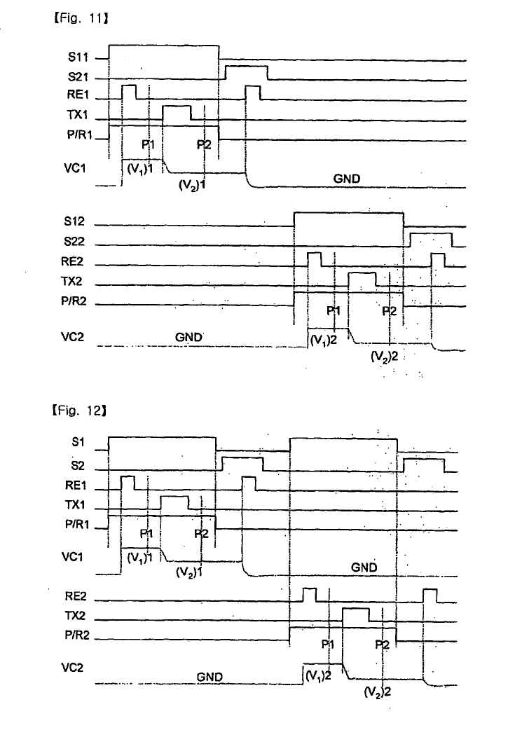

FIG. 11 is a waveform diagram of signals associated with the operations of the pixel array illustrated in FIG. 8.

Referring to FIG. 11, the first of the first control signals S11, the first of the second control signal S21, the first of the first pass control signal TX1, and the first of the first reset control signal RE1 are enabled or disabled as a group. Here, the remaining first control signals S12 to S1N, the remaining second control signals S22 to S2N, the remaining pass control signals TX2 to TXN, and the remaining reset control signals RE2 to REN are disabled.

By using the first pass control signal TX1 and the first reset control signal RE1 which are enabled during a time interval in which the first of the first control signal S11 is enabled, an image signal detected by the pixel is sensed. When the first reset control signal RE1 is enabled again during a time interval in which the first of the second control signal S21 is enabled after the first of the first control signal S11 is disabled, all charges stored in the images are discharged. Here, the voltages V11 and V12 are illustrated to distinguish the voltage that is dropped at the common node VC of the pixel circuit illustrated in FIG. 4, a difference between the two voltages is referred to as a signal corresponding to a picked-up image, and the ground voltage GND is a supply voltage used to discharge the charges accumulated in the common node VC.

Next, by using the second pass control signal TX2 and the second reset control RE2 which are enabled during a time interval in which the second of the first control signal S12 is enabled, an image signal detected by the pixel is sensed. When the second reset control signal RE2 is enabled during a time interval in which the second of the second control signal S22 is enabled after the second of the first control signal S12 is disabled, all charges stored in the image sensor are discharged.

FIG. 12 is a waveform diagram of signals associated with operations of the pixel array illustrated in FIGS. 9 and 10.

Referring to FIG. 12, the first control signal S11 and the second control signal S21 are alternately enabled or disabled during a predetermined time internal, and in correspondence with this, a pass control signal TX and a reset control signal RE are sequentially enabled. When a pair of the pass control signal TX1 and the reset control signal RE1 are enabled, the remaining control signals TX2 and TXN and the remaining control signals RE2 to REN are disabled.

Operations of the pixel array which is operated in correspondence with the signals are the same as described with reference to FIGS. 8 to 11, so that a detailed description thereof is omitted.

While the present invention has been particularly shown and described with reference to exemplary embodiments thereof, it will be understood by those skilled in the art that various changes in form and details may be made therein without departing from the spirit and scope of the present invention as defined by the appended claims.

### INDUSTRIAL APPLICABILITY

As described above, since the unit pixel according to the present invention uses three MOS transistors, there is an advantage in that the number of unit pixels can be reduced, and the entire area of an image sensor including a plurality of the unit pixels can be reduced. Although the reset power supply circuit is used to supply a supply voltage to the unit pixels, a plurality of the unit pixels commonly use a single reset power supply circuit, so that the reduced area of the image sensor is larger than the area of the added reset power supply circuit. In addition, charges accumulated in the unit pixel can be discharged to a ground voltage, so that there is an advantage in that the charges accumulated in a previous step do not substantially affect a continuous image signal detection cycle.

1. A unit pixel which includes a photodiode, a charge passing unit, a reset controller, and a voltage converter and outputs a conversion voltage corresponding to a received image signal,
wherein the photodiode generates a charge in response to the image signal,
wherein the charge passing unit passes the charge generated by the photodiode to the voltage converter in response to a charge pass control signal,
wherein the reset controller supplies two or more different supply voltages to a common terminal between the charge passing unit and the voltage converter in response to a reset control signal, and
wherein the voltage converter outputs the conversion voltage corresponding to charges accumulated in a common terminal between the charge passing unit and the reset controller.

2. The unit pixel of claim 1,
wherein the two or more different supply voltages are a first supply voltage and a second supply voltage, and
wherein a level of the first supply voltage is relatively lower than a level of the second supply voltage.

3. The unit pixel of claim 2,
wherein the first supply voltage is the lowest supply voltage of supply voltages used by the unit pixel, and
wherein the second supply voltage is the highest supply voltage of the supply voltages used by the unit pixel.

4. The unit pixel of claim 1,
wherein the photodiode is a diode including the one terminal connected to a first supply voltage and the other terminal connected to the charge passing unit,
wherein the charge passing unit is a switch element which includes the one terminal connected to the other terminal of the photodiode and the other terminal commonly connected to the reset controller and the voltage converter, and is turned on or off in response to the charge pass control signal, and
wherein the reset controller is a switch element which includes the one terminal exclusively connected to two or more supply voltages and the other terminal connected to the common terminal between the charge passing unit and the voltage converter, and is turned on or off in response to the reset control signal.

5. The unit pixel of claim 4,
wherein the switch element corresponding to the charge passing unit is a charge pass MOS transistor which includes the one terminal that is a drain terminal or a source terminal, the other terminal that is a drain terminal or a source terminal, and a gate applied with the charge pass control signal, and
wherein the switch element corresponding to the reset controller is a reset control MOS transistor which includes the one terminal that is a drain terminal or a source terminal, the other terminal that is a source terminal or a drain terminal, and a gate applied with the reset control signal.

6. The unit pixel of claim 1, wherein the voltage converter is a voltage pass MOS transistor which includes the one terminal connected to the second supply voltage VDD, the other terminal that outputs the conversion voltage, and a gate commonly connected to the charge passing unit and the reset controller.

7. A pixel array in which a plurality of the unit pixels of claim 1 are two-dimensionally arrayed, comprising one or more reset power supply circuits which output two or more different supply voltages in response to a pixel selection control signal,
wherein parts of a plurality of the unit pixels share a voltage output from the reset power supply circuit.

8. The pixel array of claim 7, wherein the reset power supply circuit is shared by unit pixels of a plurality of the unit pixels included in the pixel array, that are arrayed in a column direction of a row direction.

9. The pixel array of claim 7, wherein the reset power supply circuit comprises:
a first pixel selection switch which outputs a second supply voltage in response to the pixel selection control signal; and
a second pixel selection switch which outputs a first supply voltage in response to a signal having an opposite phase to that of the pixel selection control signal.

10. The pixel array of claim 9,
wherein the first pixel selection switch is a first selection MOS transistor which includes the one terminal connected to the second supply voltage and a gate applied with the pixel selection control signal,
wherein the second pixel selection switch is a second selection MOS transistor which includes the one terminal connected to the first supply voltage and a gate applied with the signal having the opposite phase to that of the pixel selection control signal, and
wherein the other terminals of the first selection MOS transistor and the second selection MOS transistor are connected each other and connected to corresponding unit pixels.

11. The pixel array of claim 7,
wherein the two or more difference supply voltages are a first supply voltage and a second supply voltage, and
wherein a level of the first supply voltage is relatively lower than that of the second supply voltage.

12. The pixel array of claim 11,
wherein the first supply voltage is the lowest supply voltage of supply voltages used by the pixel array, and
wherein the second supply voltage is the highest supply voltage of the supply voltages used by the pixel array.

13. An image sensor including one or more of the unit pixels of claim 1 and the reset power supply circuits of claim 7.
